(19) United States
(12) Patent Application Publication
(10) Pub. No.: US 2026/0229097 A1
(43) Pub. Date: Aug. 6, 2026

(54) CONTROL DEVICE, CONTROL METHOD, AND RECORDING MEDIUM

(71) Applicant: Sony Honda Mobility Inc., Tokyo (JP)

(72) Inventors: Ryu TATE, Tokyo (JP); Masaki NISHIO, Tokyo (JP)

(73) Assignee: Sony Honda Mobility Inc., Tokyo (JP)

(21) Appl. No.: 19/043,776

(22) Filed: Feb. 3, 2025

(51) Int. Cl. G08B 6/00; G07C 5/00

(52) U.S. Cl. CPC G08B 6/00; G07C 5/008

(57) ABSTRACT

A control device, a control method, and a recording medium for enabling desired vibrations to be reproduced at a predetermined point on a driving manipulation element are provided. A control device (100) includes a processor. The processor executes a program to decompose vibrations reproduced at a predetermined point on a steering wheel (SW) of a vehicle into frequency components, perform a filtering process corresponding to at least one of a vibration characteristic of the vibration device (VD1 or VD2) mounted on the steering wheel (SW) and a vibration transmission characteristic of the steering wheel (SW) from the vibration device (VD1 or VD2) to the predetermined point on the frequency components into which the vibrations are decomposed, synthesize the frequency components on which the filtering process has been performed, and cause the vibration device (VD1 or VD2) to generate vibrations corresponding to the synthesized frequency components.

### BACKGROUND OF THE INVENTION

### Field of the Invention

The present disclosure relates to a control device, a control method, and a recording medium.

### Description of Related Art

Conventionally, technology for transmitting information to an occupant of a vehicle by vibrating a vibration device mounted on a driving manipulation element of the vehicle is known. For example, the following Patent Document 1 discloses technology for transmitting navigation information to an occupant of a vehicle by driving a plurality of actuators included in a steering mechanism of the vehicle. The following Patent Document 2 discloses technology for transmitting information indicating a left turn or a right turn to an occupant of a vehicle by vibrating a left or right vibrator located on a steering wheel that is a driving manipulation element of a vehicle.

### Patent Documents

[Patent Document 1] U.S. Pat. No. 9,623,907

[Patent Document 2] U.S. Pat. No. 10,286,922

### SUMMARY OF THE INVENTION

Meanwhile, a vibration device mounted on a driving manipulation element of a vehicle has a vibration characteristic depending on a frequency. For example, the vibration device is characterized in that a vibration intensity changes with a frequency of a drive signal, even if a voltage of the drive signal that is applied is constant. Moreover, the driving manipulation element of the vehicle has a vibration transmission characteristic depending on a frequency. For example, a vibration intensity of vibrations transmitted to a predetermined point on the driving manipulation element among vibrations generated by the vibration device changes with a frequency. If this frequency dependence is present, even if a drive signal for generating desired vibrations is applied to the vibration device, the desired vibrations may not be reproduced at the predetermined point on the driving manipulation element.

The present disclosure has been made in view of the above-described circumstances and an objective of the present disclosure is to provide a control device, a control method, and a recording medium for enabling desired vibrations to be reproduced at a predetermined point on a driving manipulation element.

To solve the above-described problems, according to a first aspect of the present disclosure, there is provided a control device (100 or 100A) for controlling vibrations generated by a vibration device (VD1 or VD2) mounted on a driving manipulation element (SW) of a vehicle (M), the control device including: a processor, the processor executing a program to decompose vibrations reproduced at a predetermined point (P) on the driving manipulation element into frequency components, perform a filtering process corresponding to at least one of a vibration characteristic of the vibration device and a vibration transmission characteristic of the driving manipulation element from the vibration device to the predetermined point on the frequency components into which the vibrations are decomposed, synthesize the frequency components on which the filtering process has been performed, and cause the vibration device to generate vibrations corresponding to the synthesized frequency components.

According to a second aspect of the present disclosure, in the control device according to the first aspect of the present disclosure, the processor may perform the filtering process using a filter having an inverse characteristic of a characteristic expressed by a product of the vibration characteristic of the vibration device and the vibration transmission characteristic of the driving manipulation element from the vibration device to the predetermined point.

According to a third aspect of the present disclosure, in the control device according to the second aspect of the present disclosure, the processor may generate the filter using the vibration characteristic of the vibration device and the vibration transmission characteristic of the driving manipulation element from the vibration device to the predetermined point.

According to a fourth aspect of the present disclosure, in the control device according to any one of the first to third aspects of the present disclosure, the processor may acquire a detection result of a detection sensor (40) that detects at least one of a surrounding situation of the vehicle, a state of the vehicle, and a driving situation of the vehicle, and cause the vibration device to generate the vibrations corresponding to at least one of the surrounding situation of the vehicle, the state of the vehicle, and the driving situation of the vehicle in accordance with the acquired detection result.

According to a fifth aspect of the present disclosure, in the control device according to the fourth aspect of the present disclosure, the processor may generate the vibrations corresponding to at least one of the surrounding situation of the vehicle, the state of the vehicle, and the driving situation of the vehicle.

According to a sixth aspect of the present disclosure, in the control device according to the fourth aspect of the present disclosure, the processor may transmit the acquired detection result to a server device (300), receive definition information for defining the vibrations corresponding to at least one of the surrounding situation of the vehicle, the state of the vehicle, and the driving situation of the vehicle transmitted from the server device in accordance with the detection result transmitted to the server device, and cause the vibration device to generate the vibrations based on the received definition information.

According to a seventh aspect of the present disclosure, in the control device according to any one of the first to sixth aspects of the present disclosure, the processor may perform control so that a vibration intensity of the vibration device gradually increases or decreases within a prespecified transition period at a start or end of the vibrations of the vibration device.

According to an aspect of the present disclosure, there is provided a control method for controlling vibrations generated by a vibration device (VD1 or VD2) mounted on a driving manipulation element (SW) of a vehicle (M), the control method including: decomposing, by a computer, vibrations reproduced at a predetermined point (P) on the driving manipulation element into frequency components; performing, by the computer, a filtering process corresponding to at least one of a vibration characteristic of the vibration device and a vibration transmission characteristic of the driving manipulation element from the vibration device to the predetermined point on the frequency components into which the vibrations are decomposed; synthesizing, by the computer, the frequency components on which the filtering process has been performed; and causing, by the computer, the vibration device to generate vibrations corresponding to the synthesized frequency components.

According to an aspect of the present disclosure, there is provided a computer-readable non-transitory recording medium recording a program for causing a computer to decompose vibrations reproduced at a predetermined point (P) on a driving manipulation element (SW) of a vehicle (M) into frequency components, perform a filtering process corresponding to at least one of a vibration characteristic of a vibration device (VD1 or VD2) mounted on the driving manipulation element and a vibration transmission characteristic of the driving manipulation element from the vibration device to the predetermined point on the frequency components into which the vibrations are decomposed, synthesize the frequency components on which the filtering process has been performed, and cause the vibration device to generate vibrations corresponding to the synthesized frequency components.

According to the present disclosure, a special operation effect of reproducing desired vibrations at a predetermined point on a driving manipulation element can be obtained.

### BRIEF DESCRIPTION OF THE DRAWINGS

FIG. 1 is a diagram schematically showing the interior of a cabin of a vehicle according to a first embodiment of the present disclosure.

FIG. 2 is a block diagram showing an exemplary configuration of a vehicle control system including a control device according to the first embodiment of the present disclosure.

FIG. 3 is a block showing an internal configuration of a generation unit according to the first embodiment of the present disclosure.

FIG. 4 is an explanatory diagram of a process performed by a second filter unit according to the first embodiment of the present disclosure.

FIG. 5 is a diagram showing an example of a path along which vibrations are transmitted in the first embodiment of the present disclosure.

FIG. 6 is an explanatory diagram of a filter for use in a second filter unit according to the first embodiment of the present disclosure.

FIG. 7 is an explanatory diagram of the control of a vibration device in the first embodiment of the present disclosure.

FIG. 8 is a flowchart showing an example of a control method according to the first embodiment of the present disclosure.

FIG. 9 is a block diagram showing a key configuration of a control device according to a second embodiment of the present disclosure.

### DETAILED DESCRIPTION OF THE INVENTION

Hereinafter, a control device, a control method, and a recording medium according to the embodiment of the present disclosure will be described in detail with reference to the drawings.

### First Embodiment

### Vehicle

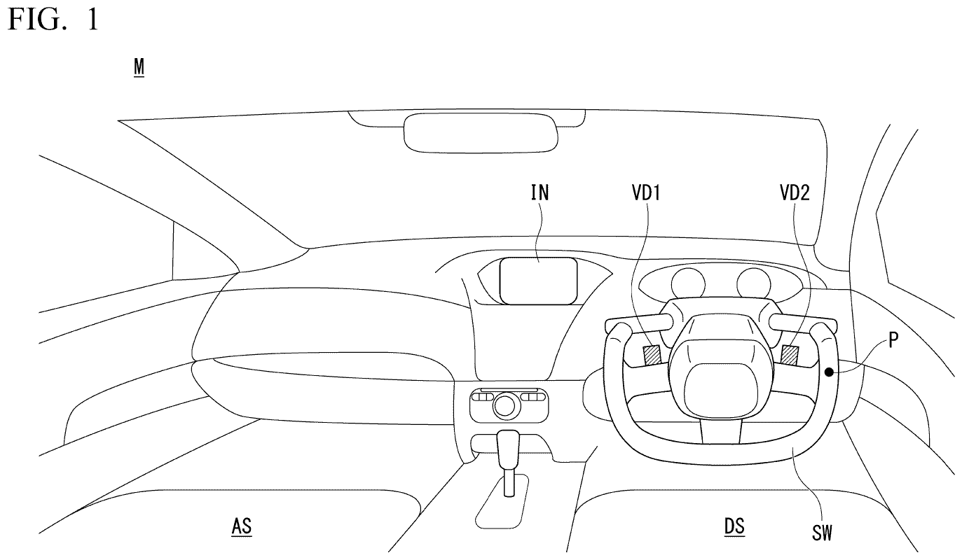

FIG. 1 is a diagram schematically showing the interior of a cabin of a vehicle according to a first embodiment of the present disclosure. As shown in FIG. 1, a vehicle M includes an instrument panel IN, a driver's seat DS, a passenger seat AS, a steering wheel SW, and the like in the vehicle cabin. The vehicle M is, for example, a vehicle such as a two-, three-, or four-wheeled vehicle, and its drive source is an internal combustion engine such as a diesel engine or a gasoline engine, an electric motor, or a combination thereof. In the present embodiment, the vehicle M will be described with reference to an example of a four-wheeled vehicle (EV) having an electric motor as a drive source.

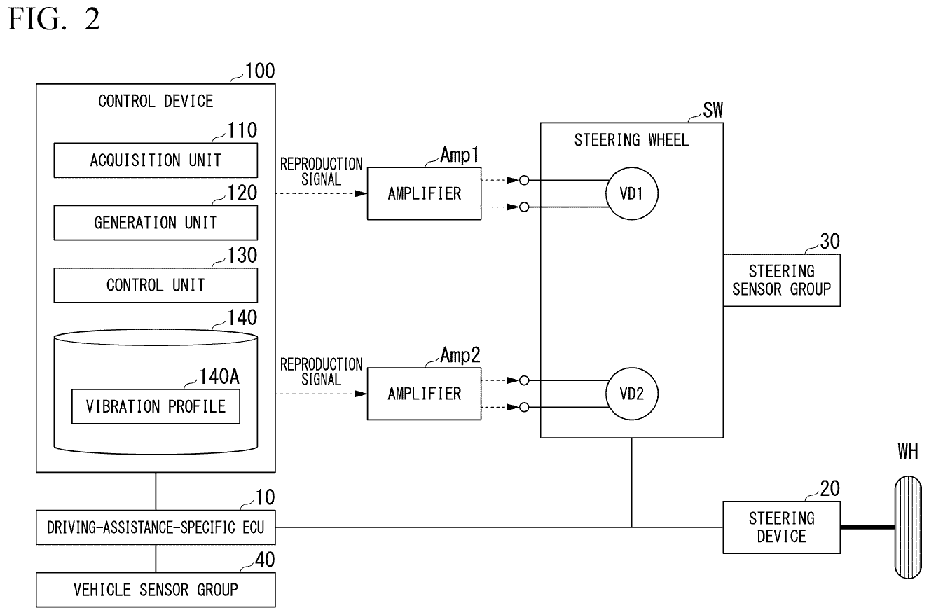

The steering wheel SW is a driving manipulation element that is manipulated by a driver of the vehicle M. A sensor that detects a manipulation amount or the presence or absence of a manipulation is attached to the steering wheel SW and its detection result is output to a driving-assistance-specific support electronic control unit (ECU) 10 and a steering device 20 (see FIG. 2). The steering wheel SW does not necessarily have to be annular, and may be an irregular steering wheel.

Moreover, the steering wheel SW is equipped with vibration devices VD1 and VD2 on the left and right sides of the steering wheel SW. The vibration devices VD1 and VD2 each have a built-in motor and generate vibrations on the steering wheel SW by operating the motor in response to a reproduction signal output from a control device 100 (see FIG. 2). The motors built into the vibration devices VD1 and VD2 may be direct-acting motors (for example, voice coil motors) or rotary motors (for example, direct current (DC) motors).

The vibration device VD1 is installed on the left side of the steering wheel SW and is used to transmit vibrations to the left hand of the driver who grips the steering wheel SW. The vibration device VD2 is installed on the right side of the steering wheel SW and is used to transmit vibrations to the right hand of the driver who grips the steering wheel SW.

### Vehicle Control System

FIG. 2 is a block diagram showing an exemplary configuration of a vehicle control system including a control device according to the first embodiment of the present disclosure. As shown in FIG. 2, the control system of the vehicle M includes the driving-assistance-specific ECU 10, the steering device 20, a steering sensor group 30, a vehicle sensor group 40 (a detection sensor), amplifiers Amp1 and Amp2, and a control device 100.

The driving-assistance-specific ECU 10 executes an advanced driver assistance system (ADAS) for the driver on the basis of a detection result of the vehicle sensor group 40. The ADAS includes, for example, a lane departure warning (LDW) that warns of the departure of the vehicle M from a travel lane. As an example, the driving-assistance-specific ECU 10 executes the ADAS by generating vibrations from the vibration devices VD1 and VD2 via the control device 100.

The steering device 20 includes, for example, a steering ECU and an electric motor. The steering ECU drives the electric motor according to information output from the driving-assistance-specific ECU 10 or information output from the steering wheel SW and causes the direction of the steering wheel to change. The electric motor, for example, acts a force on a rack and pinion mechanism to change the direction of the steering wheel.

The steering sensor group 30 is a sensor group attached to the steering wheel SW. The steering sensor group 30 includes, for example, a steering grip sensor and a vibration displacement sensor. The steering grip sensor is implemented by a capacitive sensor or the like and outputs a signal for detecting whether or not the driver is gripping the steering wheel SW (indicating that there is contact with the steering wheel SW in a state in which a force is applied) to the driving-assistance-specific ECU 10. The vibration displacement sensor measures the displacement [cm] of the vibrations generated at each position (point) of the steering wheel SW as the vibration intensity and outputs the measured vibration intensity to the control device 100. Furthermore, the vibration intensity measured by the vibration displacement sensor may be directly output to the control device 100 without going through the driving-assistance-specific ECU 10.

The vehicle sensor group 40 includes a sensor indicating a surrounding situation of the vehicle M, a sensor indicating a state of the vehicle M, and a sensor indicating a driving situation of the vehicle M. The sensor indicating the surrounding situation of the vehicle M includes an image sensor, an outside air temperature sensor, and the like installed to image the surrounding situation of the vehicle M. The sensor indicating the state of the vehicle M includes a vehicle speed sensor that detects a speed of the vehicle M, an acceleration sensor that detects acceleration, a yaw rate sensor that detects an angular velocity around a vertical axis, a direction sensor that detects a direction of the vehicle M, an air pressure sensor that detects the air pressure of a tire, and the like. The sensor indicating a driving situation of the vehicle M includes an accelerator position sensor that detects an accelerator opening degree.

Furthermore, as the image sensor, for example, a solid-state image sensor such as a charge-coupled device (CCD) or a complementary metal oxide semiconductor (CMOS) can be used. The acceleration sensor is preferably capable of detecting acceleration of the vehicle in a longitudinal direction and acceleration of the vehicle in a lateral direction. In the acceleration sensor, a sensor that detects acceleration of the vehicle in the longitudinal direction and a sensor that detects acceleration of the vehicle in the lateral direction may be integrated or separate. Furthermore, as the acceleration sensor, only a sensor that detects acceleration of the vehicle in the longitudinal direction may be provided or only a sensor that detects acceleration of the vehicle in the lateral direction may be provided.

The amplifiers Amp1 and Amp2 amplify a reproduction signal output from the control device 100, respectively. The amplifier Amp1 outputs the amplified reproduction signal to the vibration device VD1 and the amplifier Amp2 outputs the amplified reproduced signal to the vibration device VD2. The amplifiers Amp1 and Amp2 are connected to the vibration devices VD1 and VD2, respectively, via a cable reel.

### Control Device

The control device 100 includes, for example, an acquisition unit 110, a generation unit 120, a control unit 130, and a storage unit 140. The acquisition unit 110 acquires detection results of various types of sensors provided in the steering sensor group 30 and the vehicle sensor group 40. The acquisition unit 110 outputs the acquired detection results to the generation unit 120 and the control unit 130 as detection data. Furthermore, the detection data may be stored in the storage unit 140.

The generation unit 120 generates a vibration profile that is definition information for defining the vibrations (more specifically, vibration intensities, vibration frequencies, frequency and phases) of the vibration devices VD1 and VD2 in accordance with the detection results acquired by the acquisition unit 110. The vibration profile generated by the generation unit 120 is for alerting the driver to a change in the surrounding situation of the vehicle M or a change in the state of the vehicle M or producing an immersive feeling when the driver is driving the vehicle M.

The generation unit 120 generates a vibration profile that defines vibrations simulating a feeling corresponding to the road surface situation in accordance with the detection result of the sensor indicating the surrounding situation of the vehicle M provided in the vehicle sensor group 40. For example, the generation unit 120 generates a vibration profile that defines vibrations simulating an ice feeling when the road surface is frozen in accordance with the detection result of the outside air temperature sensor provided in the vehicle sensor group 40. Furthermore, in addition to the ice feeling when the road surface is frozen, the generation unit 120 may generate a vibration profile that defines vibrations simulating a feeling of the road surface during rainfall and a feeling of the road surface on a sand or muddy ground (for example, a dirt course).

The generation unit 120 generates a vibration profile that defines vibrations corresponding to the state of the vehicle M in accordance with the detection result of the sensor indicating the state of the vehicle M provided in the vehicle sensor group 40. For example, the generation unit 120 generates a vibration profile that defines vibrations simulating a tire-deflating feeling in accordance with the detection result of the air pressure sensor provided in the vehicle sensor group 40. Furthermore, in addition to the tire-deflating feeling, the generation unit 120 may generate a vibration profile that defines vibrations for providing a notification of a state of a drive source (an electric motor) or a battery.

Moreover, for example, the generation unit 120 generates a vibration profile that defines vibrations for producing a traction force (a traction feeling) due to a grip force of the tire during acceleration or deceleration or in a turning state in accordance with the detection result of the acceleration sensor provided in the vehicle sensor group 40. Alternatively, the generation unit 120 generates a vibration profile that defines vibrations for producing a speed feeling corresponding to a contact situation between the tire and the road surface in a high-speed range in accordance with the detection result of the vehicle speed sensor provided in the vehicle sensor group 40.

The generation unit 120 generates a vibration profile that defines vibrations corresponding to the driving situation of the vehicle M in accordance with the detection result of the sensor indicating the driving situation of the vehicle M provided in the vehicle sensor group 40. For example, the generation unit 120 generates a vibration profile that defines vibrations for producing a response feeling (an accelerator response feeling) of acceleration or deceleration of the vehicle M by manipulating the accelerator pedal in accordance with a detection result (an accelerator opening degree) of the accelerator position sensor provided in the vehicle sensor group 40. Furthermore, in addition to the detection result of the accelerator position sensor described above, a vibration profile may be generated by taking into account the detection result of the acceleration sensor (a sensor that detects acceleration of the vehicle in the lateral direction).

The control unit 130 vibrates the vibration devices VD1 and VD2 in accordance with the vibration profile generated by the generation unit 120 or a vibration profile 140A stored in the storage unit 140. For example, when the vibration devices VD1 and VD2 are vibrated, the control unit 130 may change vibration intensities and phases of the vibration devices VD1 and VD2 in consideration of a positional relationship of the vibration devices VD1 and VD2 and a predetermined point P (see FIG. 1). Furthermore, in the present embodiment, the predetermined point P is a position on the steering wheel SW that is generally assumed to be most frequently gripped by the driver of the vehicle M during driving and is decided in advance.

For example, when the predetermined point P is located on the right side of the steering wheel SW, the vibrations of the vibration device VD1 can be prevented from propagating to the predetermined point P by changing the vibration intensity and phase of the vibration device VD1. Likewise, for example, when the predetermined point P is located on the left side of the steering wheel SW, the vibration intensity and phase of the vibration device VD1 can be changed to prevent the vibrations of the vibration device VD2 from propagating to the predetermined point P. As a result, the driver can more clearly feel the vibrations on the left side of the steering wheel SW.

The storage unit 140 stores, for example, the vibration profile 140A, various types of parameters necessary for the generation unit 120 to generate the vibration profile, and the like. The vibration profile 140A is definition information for defining the vibrations (more specifically, the vibration intensities, vibration frequencies, frequency and phases) of the vibration devices VD1 and VD2. The vibration profile 140A is similar to the vibration profile generated by the generation unit 120, except that the vibration profile 140A is generated in advance and stored in the storage unit 140. That is, the vibration profile 140A includes, for example, a vibration profile that defines vibrations simulating an ice feeling when the road surface is frozen, a vibration profile that defines vibrations simulating a tire-deflating feeling, and the like. Moreover, the vibration profile 140A includes, for example, a vibration profile that defines vibrations for producing the above-described accelerator response feeling, a vibration profile that defines vibrations for producing a traction feeling, a vibration profile that defines vibrations for producing a speed feeling, and the like.

The acquisition unit 110, the generation unit 120, and the control unit 130 are implemented by, for example, a hardware processor such as a central processing unit (CPU) executing a program (software). Moreover, some or all of these constituent elements may be implemented by hardware (including a circuit unit; circuitry) such as a large-scale integration (LSI) circuit, an application-specific integrated circuit (ASIC), a field-programmable gate array (FPGA), a graphics processing unit (GPU), and a system on chip (SOC) or may be implemented by software and hardware in cooperation.

The program may be stored in a storage device such as a hard disk drive (HDD) or flash memory (a storage device including a non-transitory storage medium) of the control device 100 in advance. Alternatively, the program may be stored in a removable recording medium such as a DVD or CD-ROM and installed in the HDD or flash memory of the control device 100 when the recording medium (non-transitory recording medium) is mounted on a drive device.

The storage unit 140 is implemented by a storage device such as an HDD, a flash memory, or a random-access memory (RAM). The storage unit 140 may be fixed to the control device 100 or may be detachably provided on the control device 100.

### Vibration Profile Generation Method

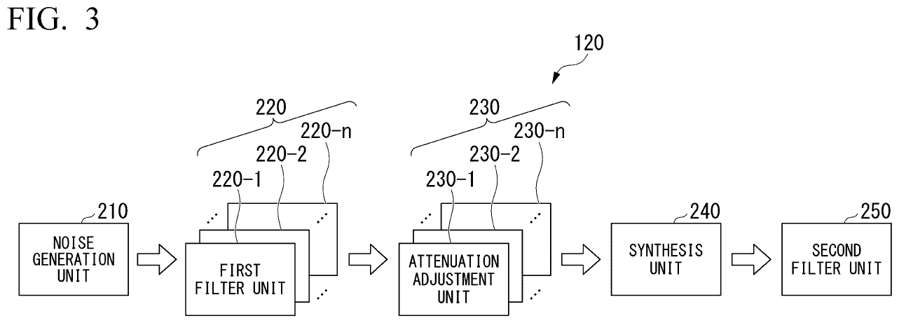

FIG. 3 is a block showing an internal configuration of the generation unit according to the first embodiment of the present disclosure. As shown in FIG. 3, the generation unit 120 includes a noise generation unit 210, a first filter unit 220, an envelope adjustment unit 230, a synthesis unit 240, and a second filter unit 250.

The noise generation unit 210 generates a noise signal. The noise signal generated by the noise generation unit 210 is, for example, a signal including pink or white noise. Furthermore, the noise signal generated by the noise generation unit 210 is not limited to a signal including pink noise or white noise and may include any noise.

The first filter unit 220 includes a plurality of frequency filters 220-1 to 220-n (n is an integer of 2 or more). Each of the frequency filters 220-1 to 220-n is, for example, a bandpass filter that passes a frequency in only a predetermined frequency band. Furthermore, each of the frequency filters 220-1 to 220-n may be a low-pass filter that passes a frequency less than or equal to a predetermined frequency or a high-pass filter that passes a frequency greater than or equal to the predetermined frequency.

The pass frequency bands of the frequency filters 220-1 to 220-n can be set individually. By adjusting the pass frequency bands of the frequency filters 220-1 to 220-n, for example, vibrations simulating the ice feeling when the road surface is frozen, vibrations simulating the tire-deflating feeling, vibrations for producing the above-described accelerator response feeling, traction feeling, and speed feeling and the like, or the like can be generated.

The envelope adjustment unit 230 includes a plurality of attenuation adjustment units 230-1 to 230-n. The attenuation adjustment units 230-1 to 230-n are each provided in association with the frequency filters 220-1 to 220-n. The attenuation adjustment units 230-1 to 230-n attenuate signals output from the corresponding frequency filters 220-1 to 220-n. That is, the envelope adjustment unit 230 adjusts the envelope of the signal output from each of the frequency filters 220-1 to 220-n.

An attenuation amount, an attenuation coefficient, and an attenuation method in the attenuation adjustment units 230-1 to 230-n can be set individually. By individually adjusting the attenuation amount in the attenuation adjustment units 230-1 to 230-n, for example, vibrations simulating the ice feeling when the road surface is frozen, vibrations simulating the tire-deflating feeling, vibrations for producing the above-described accelerator response feeling, traction feeling, and speed feeling and the like, or the like can be generated.

The synthesis unit 240 synthesizes signals output from the attenuation adjustment units 230-1 to 230-n of the envelope adjustment unit 230. For example, the synthesis unit 240 performs a synthesis process by superimposing the signals output from the attenuation adjustment units 230-1 to 230-n. Furthermore, when the synthesis unit 240 synthesizes the signals output from the attenuation adjustment units 230-1 to 230-n output from the attenuation adjustment units 230-1 to 230-n, the intensity of the signal output from each of the attenuation adjustment units 230-1 to 230-n may be adjusted.

The second filter unit 250 performs a process of multiplying the signals synthesized by the synthesis unit 240 by an inverse function of a vibration transmission function of the vehicle M. This process is performed so that the signals synthesized by the synthesis unit 240 are reproduced at a position where the vibrations are reproduced (for example, at positions where the vibration devices VD1 and VD2 are provided or at the predetermined point P). Thereby, a vibration profile is generated.

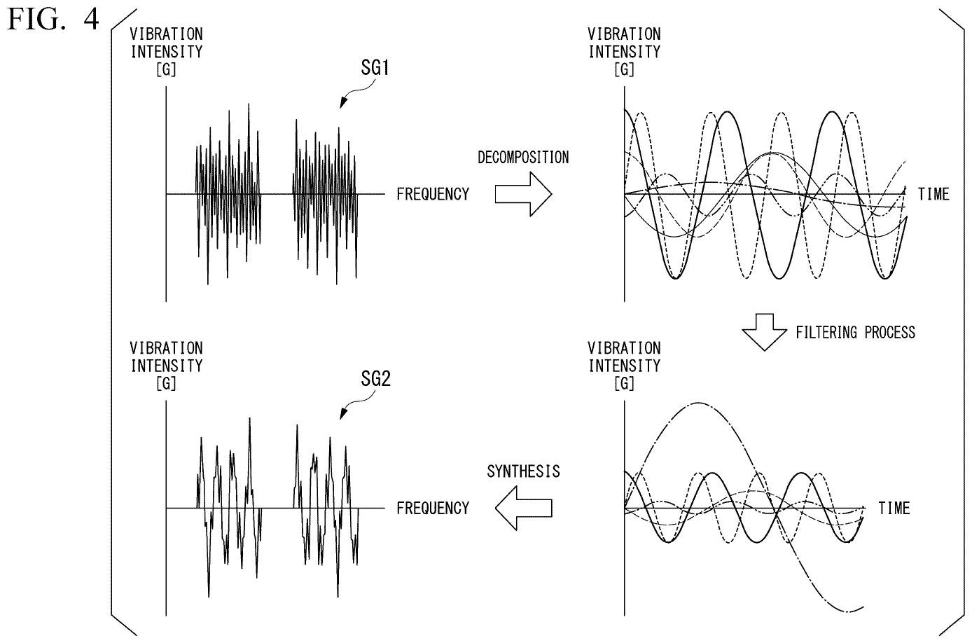

FIG. 4 is an explanatory diagram of a process performed by the second filter unit according to the first embodiment of the present disclosure. A signal SG1 shown in FIG. 4 is an example of a signal synthesized by the synthesis unit 240 and a signal SG2 is an example of a signal processed by the second filter unit 250. A waveform of the signal SG1 is, for example, a waveform of vibrations (desired vibrations) to be reproduced at the predetermined point P on the steering wheel SW, and a waveform of the signal SG2 is a waveform of a reproduction signal that is output to the vibration devices VD1 and VD2.

The second filter unit 250 first decomposes the signal SG1 on which the synthesis unit 240 has performed synthesis into frequency components. For example, the second filter unit 250 performs a Fourier transform on the signal on which the synthesis unit 240 has performed synthesis and decomposes a Fourier transform result into frequency components. Subsequently, the second filter unit 250 performs a filtering process corresponding to a vibration characteristic of the vibration device VD1 or VD2 and a vibration transmission characteristic of the steering wheel SW from the vibration device VD1 or VD2 to the predetermined point P with respect to the frequency components obtained by the decomposition.

Also, the second filter unit 250 synthesizes the filtered frequency components to generate the signal SG2. For example, the second filter unit 250 performs an inverse Fourier transform on the filtered frequency components to generate the signal SG2. When this signal SG2 is output to the vibration devices VD1 and VD2 as a reproduction signal, vibrations corresponding to the signal SG2 are generated.

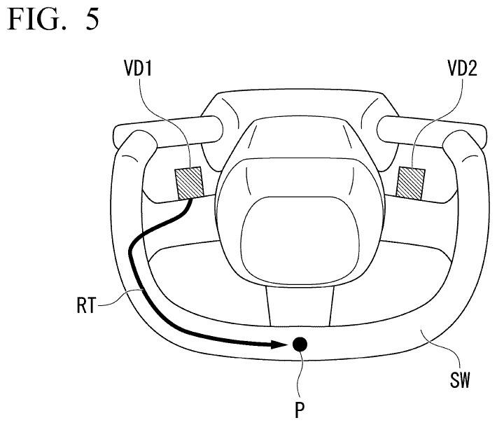

FIG. 5 is a diagram showing an example of a path along which vibrations are transmitted in the first embodiment of the present disclosure. Here, for ease of understanding, it is assumed that the predetermined point P is set on a lower portion of the steering wheel SW and only the vibrations generated by the vibration device VD1 are transmitted to the predetermined point P via a path RT. Furthermore, the predetermined point P is, for example, a portion gripped by the driver of the vehicle M. Furthermore, a position of the predetermined point P can be detected by the steering grip sensor of the steering sensor group 30 shown in FIG. 2.

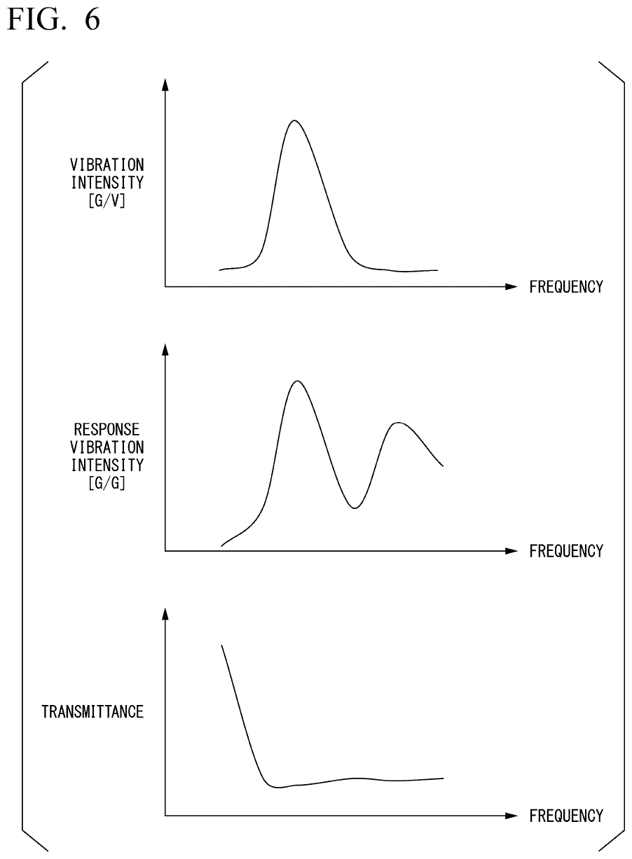

FIG. 6 is an explanatory diagram of a filter for use in the second filter unit according to the first embodiment of the present disclosure. In FIG. 6, an upper graph shows an example of a vibration characteristic of the vibration device VD1 and a middle graph shows an example of a vibration transmission characteristic of the steering wheel SW on the path RT from the vibration device VD1 to the predetermined point P. In FIG. 6, a lower graph shows an example of a characteristic of a filter for use in the second filter unit 250.

In the upper graph shown in FIG. 6, the horizontal axis represents a frequency and the vertical axis represents a vibration intensity. Here, the vibration intensity of the vertical axis indicates a level of acceleration [G] corresponding to the vibrations capable of being obtained when a voltage of 1 [V] is applied to the vibration device VD1. In the middle graph shown in FIG. 6, the horizontal axis represents a frequency and the vertical axis represents a response vibration intensity. Here, the response vibration intensity of the vertical axis indicates a level of acceleration [G] capable of being obtained at a point of interest (the predetermined point P) when vibrations corresponding to the acceleration of 1 [G] are applied. In the lower graph shown in FIG. 6, the vertical axis represents a frequency and the horizontal axis represents vibration transmittance.

If the vibration characteristic of the vibration device VD1 shown in the upper portion of FIG. 6 is denoted by A and the vibration transmission characteristic of the steering wheel SW on the path RT shown in the middle portion of FIG. 6 is denoted by B, a characteristic of the filter shown in the lower graph of FIG. 6 is expressed by (1/(A×B)). That is, the filter used in the second filter unit 250 has an inverse characteristic of a characteristic expressed by a product of the vibration characteristic A of the vibration device VD1 and the vibration transmission characteristic B of the steering wheel SW on the path RT from the vibration device VD1 to the predetermined point P.

Thus, the filter shown in the lower graph of FIG. 6 is generated using the vibration characteristic A of the vibration device VD1 shown in the upper graph of FIG. 6 and the vibration transmission characteristic B of the steering wheel SW on the path RT shown in the middle graph of FIG. 6. The filter shown in the lower graph of FIG. 6 may be generated in advance and stored in the second filter unit 250 or and may be generated when the second filter unit 250 performs a filtering process.

Here, the vibration characteristic A of the vibration device VD1 hardly changes, while the vibration transmission characteristic B of the steering wheel SW changes in accordance with the path RT from the vibration device VD1 to the predetermined point P. When the filter is stored in the second filter unit 250, it is necessary to store a plurality of filters in advance in correspondence with the path RT from the vibration device VD1 to the predetermined point P. Moreover, when the second filter unit 250 generates a filter, it is necessary to store the vibration characteristic A of the vibration device VD1 and a plurality of vibration transmission characteristics B corresponding to the path RT from the vibration device VD1 to the predetermined point P in the second filter unit 250.

As described above, the characteristic of the filter shown in the lower graph of FIG. 6 has an inverse characteristic of a characteristic expressed by a product of the vibration characteristic A of the vibration device VD1 and the vibration transmission characteristic B of the steering wheel SW on the path RT from the vibration device VD1 to the predetermined point P. For this reason, if the signal SG2 shown in FIG. 4 is output to the vibration device VD1 as a reproduction signal, the signal SG1 waveform shown in FIG. 4 is reproduced at the predetermined point P on the steering wheel SW shown in FIG. 5. In this way, desired vibrations can be reproduced at the predetermined point P on the steering wheel SW.

### Control of Vibration Devices

As described above, the control unit 130 vibrates the vibration devices VD1 and VD2 in accordance with the vibration profile generated by the generation unit 120 or the vibration profile 140A stored in the storage unit 140. When the vibration devices VD1 and VD2 are vibrated in accordance with the vibration profile, the control unit 130 performs control so that the vibration intensities of the vibration devices VD1 and VD2 gradually increase or decrease within a prespecified transition period at the start or end of the vibrations. This control is performed to prevent the occurrence of the failure or abnormal noise in the vibration devices VD1 and VD2 by softening the sudden operations of the vibration devices VD1 and VD2.

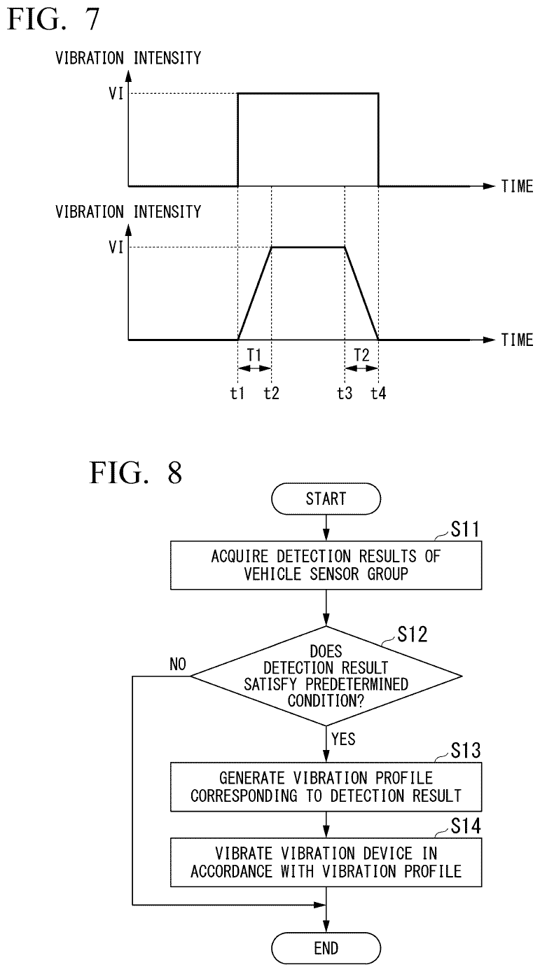

FIG. 7 is an explanatory diagram of the control of a vibration device in the first embodiment of the present disclosure. For example, as shown in the upper graph of FIG. 7, it is assumed that the vibration profile for use in the control unit 130 causes the vibrations having a vibration intensity of VI to start at time t1 and causes the vibrations having the vibration intensity of VI to end at time t4. As shown in the lower graph of FIG. 7, the control unit 130 performs control so that the vibration intensity gradually increases from 0 within a transition period T1 set between times t1 and t2 at the start of the vibrations and the vibration intensity becomes VI at time t2. Moreover, the control unit 130 performs control so that the vibration intensity gradually decreases from VI within a transition period T2 set between times t3 and t4 at the end of the vibrations and the vibration intensity becomes 0 at time t4.

Although an example in which the vibration intensity increases linearly within the transition period T1 and the vibration intensity decreases linearly within the transition period T2 is shown in the example shown in FIG. 7, a method for changing the vibration intensity within the transition periods T1 and T2 is optional. For example, the vibration intensity may be increased or decreased in a curved or exponential manner, and may be increased or decreased step by step. Moreover, the lengths of the transition periods T1 and T2 are set to, for example, about 5 to 10 [ms]. However, the lengths of the transition periods T1 and T2 are not limited to about 5 to 10 [ms], and can be set to any lengths.

### Control Method

FIG. 8 is a flowchart showing an example of a control method according to the first embodiment of the present disclosure. Furthermore, the process of the flowchart shown in FIG. 8 is iteratively executed, for example, at regular time intervals. Furthermore, for simplicity of description, it is assumed that information indicating the position of the predetermined point P on the steering wheel SW shown in FIG. 5 is detected by the steering grip sensor of the steering sensor group 30 shown in FIG. 2.

When the process shown in FIG. 8 begins, the acquisition unit 110 of the control device 100 first acquires detection results of the vehicle sensor group 40 (step S11). For example, the acquisition unit 110 acquires detection results of the outside air temperature sensor, the air pressure sensor, the accelerator position sensor, the acceleration sensor, the vehicle speed sensor, and the other sensors provided in the vehicle sensor group 40. Furthermore, the detection results acquired by the acquisition unit 110 are output to the generation unit 120 and the control unit 130.

Subsequently, the control unit 130 of the control device 100 determines whether or not the detection result acquired by the acquisition unit 110 satisfies a predetermined condition (step S12). For example, the control device 100 determines whether or not at least one of the detection result of the outside air temperature sensor, the detection result of the air pressure sensor, the detection result of the accelerator position sensor, the detection result of the acceleration sensor, and the detection result of the vehicle speed sensor exceeds a preset threshold value for each detection result.

When the control unit 130 determines that the detection result acquired by the acquisition unit 110 does not satisfy a predetermined condition (when the determination result in step S12 is “NO”), the process of the flowchart shown in FIG. 8 ends. On the other hand, when the control unit 130 determines that the detection result acquired by the acquisition unit 110 satisfies the predetermined condition (when the determination result in step S12 is “YES”), the generation unit 120 generates a vibration profile corresponding to the detection result (step S13).

For example, when the detection result of the outside air temperature sensor is less than or equal to the reference temperature, the generation unit 120 generates a vibration profile that defines vibrations simulating an ice feeling when the road surface is frozen. When the detection result of the air pressure sensor is less than or equal to the reference pressure, the generation unit 120 generates a vibration profile that defines vibrations simulating a tire-deflating feeling.

Alternatively, when the result of the accelerator position sensor is greater than a predetermined threshold value, the generation unit 120 generates a vibration profile that defines vibrations for producing an accelerator response feeling. When the detection result of the acceleration sensor is equal to or greater than the threshold value, the generation unit 120 generates a vibration profile that defines vibrations for producing a traction feeling. When the detection result of the vehicle speed sensor is equal to or greater than the threshold value, the generation unit 120 generates a vibration profile that defines vibrations for producing a speed feeling.

Furthermore, the generation unit 120 generates a vibration profile by the method described with reference to FIGS. 3 to 6. That is, the vibration profile generated by the generation unit 120 is obtained by performing a filtering process corresponding to the vibration characteristic of the vibration device VD1 shown in the upper graph of FIG. 6 and the vibration transmission characteristics of the steering wheel SW on the path RT shown in the middle graph of FIG. 6.

Subsequently, the control unit 130 vibrates the vibration device VD1 in accordance with the vibration profile generated by the generation unit 120 (step S14). For example, the control unit 130 vibrates the vibration device VD1 in accordance with a vibration profile that defines vibrations simulating the ice feeling when the road surface is frozen. Thereby, the ice feeling is reproduced when the road surface is frozen at a predetermined point P shown in FIG. 5. Alternatively, the control unit 130 vibrates the vibration device VD1 in accordance with a vibration profile that defines vibrations simulating the tire-deflating feeling. Thereby, the tire-deflating feeling is reproduced at the predetermined point P shown in FIG. 5.

Moreover, for example, the control unit 130 vibrates the vibration device VD1 in accordance with a vibration profile that defines vibrations for producing the accelerator response feeling. Thereby, the vibrations for producing the accelerator response feeling are reproduced at the predetermined point P shown in FIG. 5. Moreover, the control unit 130 vibrates the vibration device VD1 in accordance with the vibration profile that defines vibrations for producing the traction feeling. Thereby, the vibrations for producing the traction feeling are reproduced at the predetermined point P shown in FIG. 5. Alternatively, the control unit 130 vibrates the vibration device VD1 in accordance with a vibration profile that defines vibrations for producing the speed feeling. Thereby, the vibrations for producing the speed feeling are reproduced at the predetermined point P shown in FIG. 5.

By performing the above-described process, vibrations corresponding to at least one of the surrounding situation of the vehicle M, the state of the vehicle M, and the driving situation of the vehicle M are generated by the vibration device VD1 and transmitted to the predetermined point P via the path RT shown in FIG. 5. Here, the vibrations generated by the vibration device VD1 are obtained by performing a filtering process using the filter as shown in the lower graph of FIG. 6. For this reason, even if the vibration characteristic of the vibration device VD1 and the vibration transmission characteristic of the steering wheel SW on the path RT depend on a frequency, the desired vibrations can be reproduced at the predetermined point P on the steering wheel SW. As a result, for example, it is possible to reproduce a texture during driving such as the ice feeling when the road surface is frozen or the tire-deflating feeling. Alternatively, it is possible to produce an immersive feeling during driving by reproducing the accelerator response feeling, the traction feeling, the speed feeling, or the like.

Furthermore, an example in which the generation unit 120 generates a vibration profile (step S13) and the control unit 130 vibrates the vibration device VD1 in accordance with the generated vibration profile (step S14) has been described with reference to FIG. 8. However, the step of selecting the vibration profile 140A corresponding to the detection result and reading the vibration profile 140A from the storage unit 140 may be executed instead of step S13. Thereby, the vibration profile 140A corresponding to the detection result of the vehicle sensor group 40 is selected and read from the storage unit 140 and the vibration device VD1 is vibrated in accordance with the read vibration profile.

Moreover, for simplicity of description, an example in which only the vibration device VD1 is vibrated has been described with reference to FIG. 8. However, the vibration device VD2 may be vibrated instead of the vibration device VD1, and the vibration device VD1 and the vibration device VD2 may be vibrated together. Moreover, for simplicity of description, a case where the number of predetermined points P of the steering wheel SW is one has been described with reference to FIG. 8. However, the number of predetermined points P may be two or more as in a case where the driver of the vehicle M grips the steering wheel SW with both hands.

For example, a case where the vibration device VD1 and the vibration device VD2 are vibrated together and there are two predetermined points P is considered. In this case, it is only necessary to perform a filtering process corresponding to a vibration characteristic of the vibration device VD1 and a vibration transmission characteristic corresponding to a path from the vibration device VD1 to one predetermined point P with respect to the vibrations generated by the vibration device VD1. Moreover, it is only necessary to perform a filtering process corresponding to a vibration characteristic of the vibration device VD2 and a vibration transmission characteristic corresponding to a path from the vibration device VD2 to the other predetermined point P with respect to the vibrations generated by the vibration device VD2.

As described above, in the present embodiment, the second filter unit 250 decomposes vibrations reproduced at the predetermined point P on the steering wheel SW into frequency components, performs a filtering process corresponding to at least one of a vibration characteristic of the vibration device VD1 and a vibration transmission characteristic of the steering wheel SW from the vibration device VD1 to the predetermined point P on the frequency components into which the vibrations are decomposed, and synthesizes the frequency components on which the filtering process has been performed. Also, the vibration device VD1 is allowed to generate vibrations corresponding to the synthesized frequency components. Thereby, even if the vibration characteristic of the vibration device VD1 and the vibration transmission characteristic of the steering wheel SW on the path RT depend on a frequency, the desired vibrations can be reproduced at the predetermined point P on the steering wheel SW.

### Second Embodiment

### Control Device

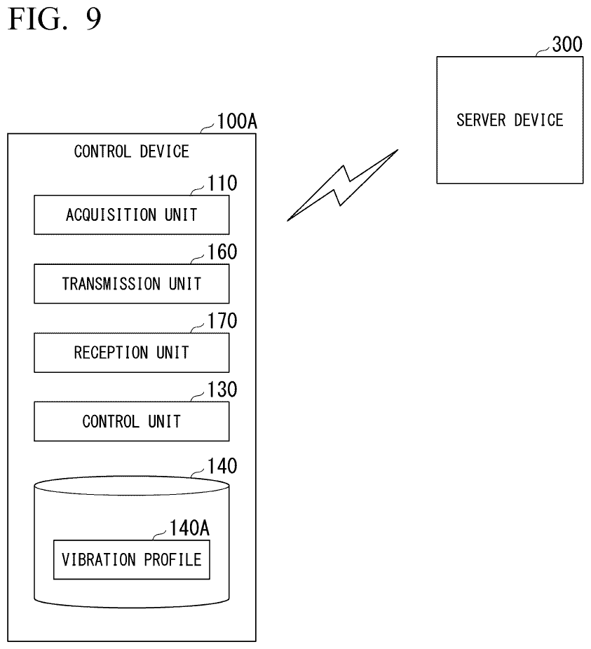

FIG. 9 is a block diagram showing a key configuration of a control device according to a second embodiment of the present disclosure. Furthermore, like the control device 100 shown in FIG. 2, a control device 100A of the present embodiment is mounted on the vehicle and causes vibration devices VD1 and VD2 to generate vibrations on a steering wheel SW.

As shown in FIG. 9, the control device 100A of the present embodiment has a configuration of a transmission unit 160 and a reception unit 170 instead of the generation unit 120 of the control device 100 shown in FIG. 2. The control device 100 of the first embodiment uses the vibration profile 140A stored in the storage unit 140 or the vibration profile generated by the generation unit 120. On the other hand, the control device 100A of the present embodiment uses a vibration profile transmitted from a server device 300.

The transmission unit 160 and the reception unit 170 are wirelessly connected to the server device 300. For example, the transmission unit 160, the reception unit 170, and the server device 300 are wirelessly connected through 4G (a fourth-generation mobile communication system) or 5G (a fifth-generation mobile communication system). Connection forms between the transmission unit 160 and the reception unit 170 and the server device 300 are not limited to 4G or 5G and may be any connection forms. In the transmission unit 160 and the reception unit 170, information indicating the address of the server device 300 is preset. The transmission unit 160 and the reception unit 170 can communicate with the server device 300 by identifying the server device 300 through an address.

The transmission unit 160 transmits detection results of a steering sensor group 30 and a vehicle sensor group 40 acquired by an acquisition unit 110 to the server device 300. For example, the transmission unit 160 may transmit the detection results of the steering sensor group 30 to the server device 300 only when a grip position on a steering wheel SW has changed. Moreover, in step S12 of FIG. 8, the transmission unit 160 may transmit only a detection result of a control unit 130 determining that a predetermined condition is satisfied to the server device 300 with respect to the detection results of the vehicle sensor group 40. The reception unit 170 receives the vibration profile transmitted from the server device 300 as a reply to the detection result transmitted by the transmission unit 160. The reception unit 170 outputs the received vibration profile to the control unit 130. Furthermore, the vibration profile received by the reception unit 170 may be stored in a storage unit 140.

The server device 300 transmits a vibration profile corresponding to the detection result transmitted from the control device 100A to the control device 100A. For example, the server device 300 includes a part similar to the generation unit 120 described with reference to FIG. 3 and a vibration profile corresponding to the detection result transmitted from the control device 100A may be generated by the method described with reference to FIGS. 3 to 6. Furthermore, the method by which the server device 300 generates the vibration profile is not limited to the method described with reference to FIGS. 3 to 6 and may be another method.

Alternatively, the server device 300 may store a wide variety of vibration profiles in advance, read the vibration profile corresponding to the detection result transmitted from the control device 100A, and transmit the read vibration profile to the control device 100A. Because the server device 300 can include a storage unit having a larger capacity than the storage unit 140 mounted on the vehicle M, a wide variety of vibration profiles can be stored.

### Control Method

The control method of the present embodiment is similar to that of the first embodiment, except that the vibration profile transmitted from the server device 300 is used. That is, in the control method according to the second embodiment of the present disclosure, for example, “generating a vibration profile corresponding to the detection result” in step S13 shown in FIG. 8 is replaced with “transmitting the detection result to the server device and receiving the vibration profile transmitted from the server device.” Hereinafter, the control method of the second embodiment will be described with reference to FIG. 8 whose part of the control method is replaced.

In the present embodiment, when the process begins, the acquisition unit 110 of the control device 100 acquires a detection result of the vehicle sensor group 40 as in the first embodiment (step S11). Subsequently, the control unit 130 of the control device 100 determines whether or not the detection result acquired by the acquisition unit 110 satisfies a predetermined condition (step S12). When the control unit 130 determines that the detection result acquired by the acquisition unit 110 does not satisfy the predetermined condition (when the determination result in step S12 is “NO”), the process of the flowchart shown in FIG. 8 ends.

On the other hand, when the control unit 130 determines that the detection result acquired by the acquisition unit 110 satisfies the predetermined condition (when the determination result in step S12 is “YES”), the transmission unit 160 transmits a detection result indicating that the predetermined condition is satisfied to the server device 300. Also, the reception unit 170 receives the vibration profile transmitted from the server device 300 as a reply to the detection result transmitted by the transmission unit 160 (step S13 of the replacement).

Subsequently, the control unit 130 vibrates vibration devices VD1 and VD2 in accordance with the vibration profile generated by the generation unit 120 (step S14). For example, the control unit 130 vibrates the vibration devices VD1 and VD2 in accordance with a vibration profile that defines vibrations simulating an ice feeling when a road surface is frozen. Alternatively, the control unit 130 vibrates the vibration devices VD1 and VD2 in accordance with a vibration profile that defines vibrations for producing the accelerator response feeling, the traction feeling, or the speed feeling. Thereby, the ice feeling when the road surface is frozen is reproduced or the accelerator feeling response, the traction feeling, or the speed feeling is produced.

By performing the above-described process, vibrations corresponding to at least one of the surrounding situation of the vehicle M, the state of the vehicle M, and the driving situation of the vehicle M are generated by the vibration device VD1 or VD2. Thereby, even if the vibration characteristic of the vibration device VD1 or VD2 and the vibration transmission characteristic of the steering wheel SW depend on a frequency, the desired vibrations can be reproduced at the predetermined point P on the steering wheel SW.

As described above, even in the present embodiment, the second filter unit 250 decomposes vibrations produced at the predetermined point P on the steering wheel SW into frequency components, performs a filtering process corresponding to at least one of a vibration characteristic of the vibration device VD1 and a vibration transmission characteristic of the steering wheel SW from the vibration device VD1 to the predetermined point P on the frequency components into which the vibrations are decomposed, and synthesizes the frequency components on which the filtering process has been performed. Also, the vibration device VD1 is allowed to generate vibrations corresponding to the synthesized frequency components. Thereby, even if the vibration characteristics of the vibration device VD1 and the vibration transmission characteristics of the steering wheel SW on the path RT depend on a frequency, the desired vibrations can be reproduced at the predetermined point P on the steering wheel SW.

Although the control device, the control method, and the recording medium according to the embodiments of the present disclosure have been described above, the present disclosure is not limited to the above-described embodiments and can be freely changed within the scope of the present disclosure. For example, the server device 300 described in the above-described second embodiment may be implemented in a cloud computing system.

Moreover, when the vibration devices VD1 and VD2 are vibrated, vibrations in an audible range may be superimposed on the original vibrations. Alternatively, the vibrations in the audible range are emitted from a speaker in synchronization with the vibrations of the vibration devices VD1 and VD2. Thereby, hearing is reproduced in addition to a feeling, such that it is possible to better reproduce a texture during driving.

Moreover, in the above-described second embodiment, as in the first embodiment, when the vibration devices VD1 and VD2 are vibrated in accordance with the vibration profile, the control unit 130 performs control so that the vibration intensities of the vibration devices VD1 and VD2 gradually increase or decrease within a prespecified transition period at the start or end of the vibrations. Thereby, in the second embodiment, it is also possible to prevent the occurrence of the failure or abnormal noise in the vibration devices VD1 and VD2 by softening the sudden operations of the vibration devices VD1 and VD2.

Moreover, a case where the vibration characteristics of the vibration devices VD1 and VD2 are almost unchanged has been described in the above-described embodiment. However, for example, when the vibration characteristics of the vibration devices VD1 and VD2 change with a temperature, it is preferable to use vibration characteristics corresponding to a temperature. Moreover, for example, when a peripheral device such as an airbag is provided with respect to the steering wheel SW, a vibration transmission characteristic of the steering wheel SW and a vibration transmission characteristic of the peripheral device may be separately used and a characteristic obtained by synthesizing these characteristics may be used.

What is claimed is:

1. A control device for controlling vibrations generated by a vibration device mounted on a driving manipulation element of a vehicle, the control device comprising:
a processor, the processor executing a program to
decompose vibrations reproduced at a predetermined point on the driving manipulation element into frequency components,
perform a filtering process corresponding to at least one of a vibration characteristic of the vibration device and a vibration transmission characteristic of the driving manipulation element from the vibration device to the predetermined point on the frequency components into which the vibrations are decomposed,
synthesize the frequency components on which the filtering process has been performed, and
cause the vibration device to generate vibrations corresponding to the synthesized frequency components.

2. The control device according to claim 1, wherein the processor performs the filtering process using a filter having an inverse characteristic of a characteristic expressed by a product of the vibration characteristic of the vibration device and the vibration transmission characteristic of the driving manipulation element from the vibration device to the predetermined point.

3. The control device according to claim 2, wherein the processor generates the filter using the vibration characteristic of the vibration device and the vibration transmission characteristic of the driving manipulation element from the vibration device to the predetermined point.

4. The control device according to claim 1, wherein the processor
acquires a detection result of a detection sensor that detects at least one of a surrounding situation of the vehicle, a state of the vehicle, and a driving situation of the vehicle, and
causes the vibration device to generate the vibrations corresponding to at least one of the surrounding situation of the vehicle, the state of the vehicle, and the driving situation of the vehicle in accordance with the acquired detection result.

5. The control device according to claim 4, wherein the processor generates the vibrations corresponding to at least one of the surrounding situation of the vehicle, the state of the vehicle, and the driving situation of the vehicle.

6. The control device according to claim 4, wherein the processor
transmits the acquired detection result to a server device,
receives definition information for defining the vibrations corresponding to at least one of the surrounding situation of the vehicle, the state of the vehicle, and the driving situation of the vehicle transmitted from the server device in accordance with the detection result transmitted to the server device, and
causes the vibration device to generate the vibrations based on the received definition information.

7. The control device according to claim 1, wherein the processor performs control so that a vibration intensity of the vibration device gradually increases or decreases within a prespecified transition period at a start or end of the vibrations of the vibration device.

8. A control method for controlling vibrations generated by a vibration device mounted on a driving manipulation element of a vehicle, the control method comprising:
decomposing, by a computer, vibrations reproduced at a predetermined point on the driving manipulation element into frequency components;
performing, by the computer, a filtering process corresponding to at least one of a vibration characteristic of the vibration device and a vibration transmission characteristic of the driving manipulation element from the vibration device to the predetermined point on the frequency components into which the vibrations are decomposed;
synthesizing, by the computer, the frequency components on which the filtering process has been performed; and
causing, by the computer, the vibration device to generate vibrations corresponding to the synthesized frequency components.

9. A computer-readable non-transitory recording medium recording a program for causing a computer to
decompose vibrations reproduced at a predetermined point on a driving manipulation element of a vehicle into frequency components,
perform a filtering process corresponding to at least one of a vibration characteristic of a vibration device mounted on the driving manipulation element and a vibration transmission characteristic of the driving manipulation element from the vibration device to the predetermined point on the frequency components into which the vibrations are decomposed,
synthesize the frequency components on which the filtering process has been performed, and
cause the vibration device to generate vibrations corresponding to the synthesized frequency components.
